(19) United States
(12) Patent Application Publication
(10) Pub. No.: US 2014/0253867 A1
(43) Pub. Date: Sep. 11, 2014

(54) Pair of Projector Glasses

(71) Applicants: Tao Jiang, Beijing (CN); Dazhang Zeng, Chengdu (CN)

(72) Inventors: Tao Jiang, Beijing (CN); Dazhang Zeng, Chengdu (CN)

(21) Appl. No.: 14/198,583

(22) Filed: Mar. 5, 2014

Related U.S. Application Data
(60) Provisional application No. 61/772,906, filed on Mar. 5, 2013.

(51) Int. Cl. G02C 11/00

(52) U.S. Cl. CPC G02C 11/10
USPC 351/158

(57) ABSTRACT

A pair of projector glasses is an eyewear apparatus that provides a user with a convenient means of acquiring, viewing, and listening to digital content. The eyewear apparatus mainly includes a glasses frame, a pair of temples, a projector, a wireless module, a pair of headphone speakers, and a pair of portable power sources. The glasses frame and the pair of temples are used to support the eyewear apparatus on the user's head. The wireless module retrieves digital content from an external source such as a smart-phone, a computer, or the Internet. The wireless module then distributes the audio portion of the digital content to the pair of speakers and the visual portion of the digital content to the projector. The portable power sources are separately positioned on the eyewear apparatus so that each source can power the electrical components that are in close proximity to the source itself.

The current application claims a priority to the U.S. Provisional Patent application Ser. No. 61/772,906 filed on Mar. 5, 2013.

### FIELD OF THE INVENTION

The present invention relates generally to projectors, audio, and wireless technologies. More specifically, the present invention is a pair of glasses with an integrated projector system for wirelessly acquiring and playing videos from an external source.

### BACKGROUND OF THE INVENTION

Projectors have a wide variety of applications in fields including, but not limited to, educational, corporate, and entertainment. Educational instructors often employ projectors as teaching aids to display both still images and videos to their students. In the corporate field, projectors are commonly utilized in presentations and demonstrations. Finally, the entertainment industry primarily relies on video projectors for the releases of feature films. Projectors are available in a wide variety of sizes and designs to accommodate the numerous uses for the projectors. Projectors may be very large while smaller variants are able to fit within a pocket. Projectors are often integrated onto existing technologies such as camcorders and conventional point-and-shoot cameras. During normal use of a projector, a video signal is received by the projector and the projection image is projected onto an external projector screen. The present invention seeks to improve and expand upon currently existing projector technologies.

The present invention is a pair of glasses with an integrated projector, audio system, and wireless communication device. In the preferred embodiment of the present invention, the glasses do not provide any vision correction or eye protection as the glasses do not feature lenses. However, alternative embodiments of the present invention may feature glasses with vision correction and/or eye protection lenses. The frame of the glasses is held in place on a user's head by a pair of arms. A small projector is mounted to the first arm and is oriented towards the front of the wearer. A wireless communication device is mounted to the second arm and is capable of receiving video signals from external sources to be projected by the projector. The communication device utilizes wireless technology including, but not limited to, Wi-Fi, Bluetooth, and Near Field Communication (NFC). The two arms of the glasses feature adjustable in-ear headphone speakers to allow users to experience audio in addition to video. The speakers, projector, and communication device draw power from two batteries that are housed within the two arms of the glasses. The batteries are rechargeable and route power to the speakers, projector, and communication device through wires installed within the frame and arms.

The objective of the present invention is to provide users with a convenient means of acquiring and viewing a video or image. The present invention is worn on a user's head in the same manner as a normal pair of eyeglasses or sunglasses. The present invention is utilized by acquiring a video signal from an external source such as a smart-phone or computer. The video or image is projected onto a projector screen although a screen is not necessary for projection. Alternative embodiments of the present invention may feature vision correction and/or eye protection lenses. Further alternative embodiments of the present invention may feature three-dimensional stereoscopic lenses.

### BRIEF DESCRIPTION OF THE DRAWINGS

FIG. 1 is a perspective view of the present invention.

FIG. 2 is a front view of the present invention.

FIG. 3 is a schematic of the electronic components for the present invention.

FIG. 4 is a perspective view of the glasses frame for the present invention.

FIG. 5 is a perspective view of the first temple and the wireless module for the present invention.

FIG. 6 is a perspective view of the second temple and the projector for the present invention.

### DETAILED DESCRIPTIONS OF THE INVENTION

All illustrations of the drawings are for the purpose of describing selected versions of the present invention and are not intended to limit the scope of the present invention.

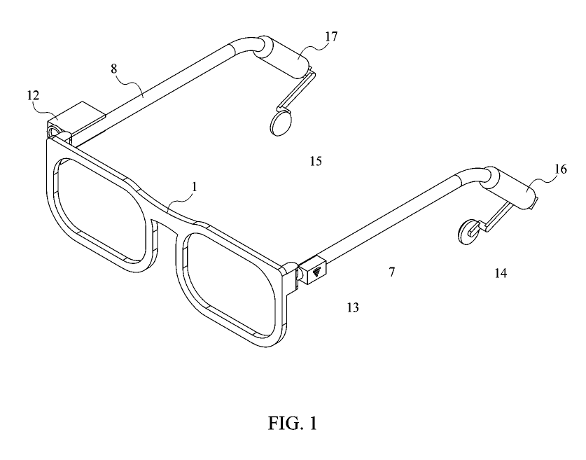

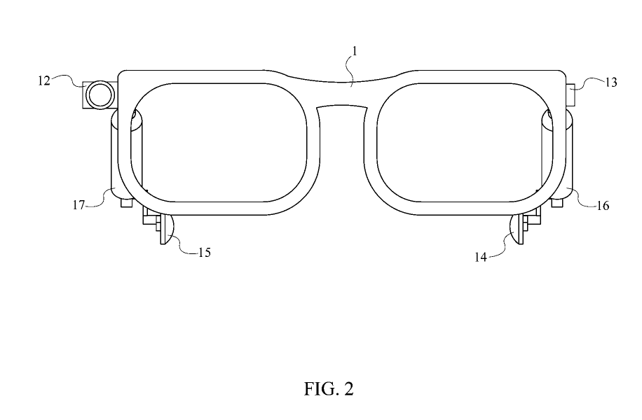

As can be seen from FIGS. 1 and 2, the present invention is a pair of projector 12 glasses that displays digital content onto a flat surface such as a white board, a wall, or a projection screen. If that digital content contains an audio portion, then the present invention will allow the user to listen to the audio portion. The present invention is also designed to retrieve digital content from an external source such as a smart-phone, a computer, or the Internet itself. The present invention mainly comprises a glasses frame 1, a first temple 7, a second temple 8, a projector 12, a wireless module 13, a first headphone speaker 14, a second headphone speaker 15, a first portable power source 16, and a second portable power source 17. The glasses frame 1 is used to support the present invention on the front of the user's face and is used as a base to connect all of the other components of the present invention together. The first temple 7 and the second temple 8 are support arms that are used to brace the present invention against the sides of the user's head and the user's ears. The wireless module 13 is the electronic device that is responsible for receiving the digital content from an external source and is responsible for properly distributing the digital content amongst the other electronic components of the present invention. The wireless module 13 may employ various wireless technologies including, but not limited to, Wi-Fi, Bluetooth, and Near Field Communication (NFC). In preferred embodiment of present invention, the wireless module 13 also has a computer component in order to interpret, manage, and properly distribute data being received by the wireless module 13. The projector 12 is an electronic device that enlarges and displays the visual portion of the digital content onto some kind of flat surface. The first headphone speaker 14 and the second headphone speaker 15 allow the user to listen to the audio portion of the digital content. The first portable power source 16 is used to power one set of electronic components that are proximal to its location, and the second portable power source 17 is used to power a different set of electronic components that are proximal to its location.

The general configuration of the present invention allows its components to efficiently retrieve, view, and listen to the digital content. The first temple 7 and the second temple 8 are positioned opposite to each other along the glasses frame 1. In addition, the first temple 7 is hingedly connected to the glasses frame 1, and the second temple 8 is hingedly connected to the glasses frame 1. This configuration allows the first temple 7 and the second temple 8 to swivel into a perpendicular position with the glasses frame 1 so that the present invention can brace against both sides of the user's head. This configuration also allows the first temple 7 and the second temple 8 to swivel into a collapsed position with the glasses frame 1 so that the present invention can be stored in smaller places. The wireless module 13 is laterally mounted onto the first temple 7, which prevents the wireless module 13 from overlapping the same space occupied by the user's head. Likewise, the projector 12 is laterally mounted onto the second temple 8, which prevents the wireless module 13 from overlapping the same space occupied by the user's head. In addition, the first headphone speaker 14 is ergonomically mounted to the first temple 7, and the second headphone speaker 15 is ergonomically mounted to the second temple 8 so that the first headphone speaker 14 and the second headphone speaker 15 can be positioned against the user's ears. This configuration allows the present invention to effectively play audio into the user's ears. Moreover, the projector 12, the first headphone speaker 14, and the second headphone speaker 15 are communicably coupled to the wireless module 13 so that the projector 12 can receive the visual portion of the digital content and so that the first headphone speaker 14 and the second headphone speaker 15 can receive the audio portion of the digital content.

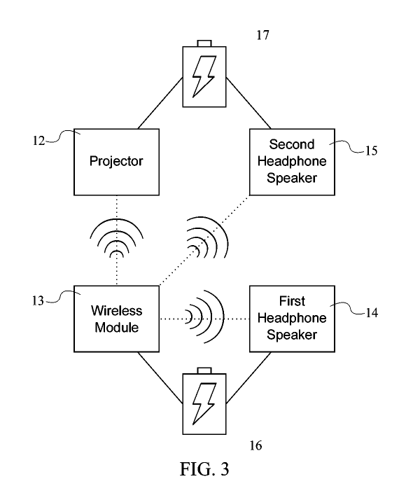

In referenced to FIG. 3, the present invention uses two separate power sources for two separate locations in order to prevent unnecessary electrical wiring from using a single power source. Thus, the first portable power source 16 is integrated into the first temple 7, which allows the first portable power source 16 to be electrically connected to the first headphone speaker 14 and the wireless module 13. Similarly, the second portable power source 17 is integrated into the second temple 8, which allows the second portable power source 17 to be electrically connected to the second headphone speaker 15 and the projector 12. This configuration of the first portable power source 16 and the second portable power source 17 prevents the need to position electrical wiring from a single power source through the hinged connections, which can lead to a mechanically difficult and cumbersome configuration. The present invention is designed to overcome this problem by using two separate power sources.

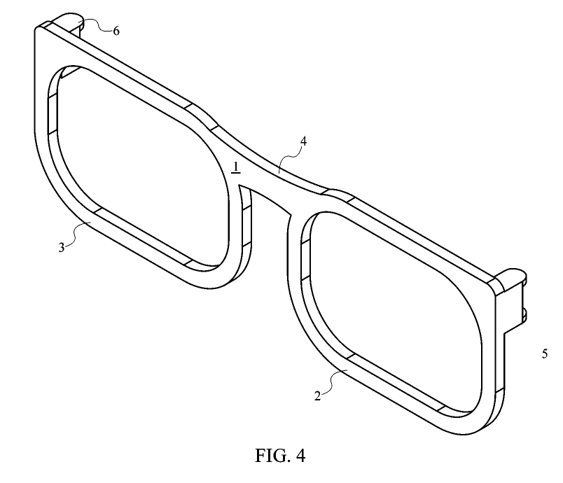

The present invention utilizes the glasses frame 1, the first temple 7, and the second temple 8 as a means to securely mount and to accurately orient the projector 12 with the user's head. The glasses frame 1 comprises a first lens rim 2, a second lens rim 3, a bridge 4, a first end point 5, and a second end point 6, which is shown in FIG. 4. The bridge 4 allows the glasses frame 1 to brace against the top of the user's nose. The bridge 4 is ergonomically connected between the first lens rim 2 and the second lens rim 3, which are designed to respectively encircle the user's eyes. In the preferred embodiment of the present invention, the first lens rim 2 and the second lens rim 3 are not used to hold any lenses and are empty so that the user's natural sight is not obstructed or altered by such lenses. However, in alternative embodiments of the present invention, the glasses frame 1 may house vision correction and/or eye protection lenses. In other alternative embodiments of the present invention, the glasses frame 1 may incorporate three-dimension stereoscopic lenses as well. The first end point 5 is connected adjacent to the first lens rim 2, opposite to the bridge 4, which allows the first temple 7 to use the first end point 5 as a mounting point onto the glasses frame 1. Thus, the first end point 5 is hingedly connected to one end of the first temple 7. Likewise, the second end point 6 is connected adjacent to the second lens rim 3, opposite to the bridge 4, which allows the second temple 8 to use the second end point 6 as a mounting point onto the glasses frame 1. Thus, the second end point 6 is hingedly connected to one end of the second temple 8.

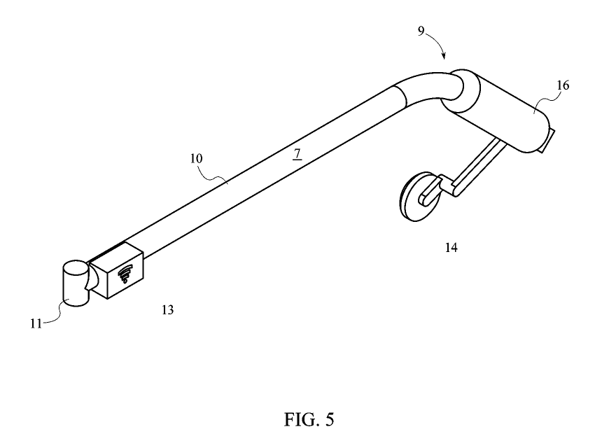

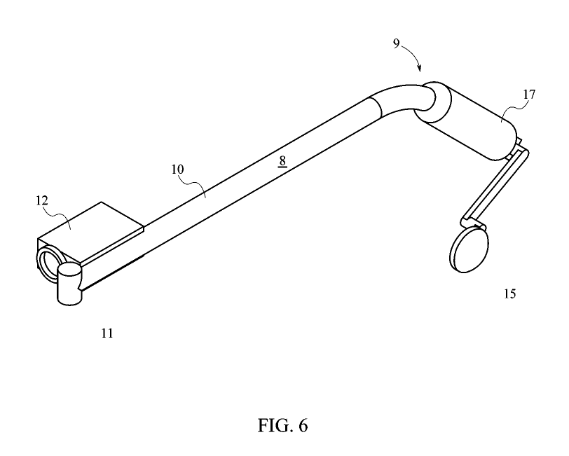

The first temple 7 and the second temple 8 are configured to optimize the spacing among their respective components. The first temple 7 and the second temple 8 each comprise a temple tip 9, a temple body 10, and a temple end 11, which are shown in FIGS. 5 and 6. The temple body 10 is the structural lengthwise body of either the first temple 7 or the second temple 8. The temple end 11 and the temple tip 9 are positioned opposite of each other along the temple body 10. The temple end 11 is the end that is used for the hinged connection between the glasses frame 1 and either the first temple 7 or the second temple 8. The temple tip 9 is allows either the first temple 7 or the second temple 8 to curve around and brace the user's ear. More specifically, for the first temple 7, the wireless module 13 is mounted along the temple body 10 adjacent to the temple end 11 so that the wireless module 13 is structurally support away from the user's head and, thus, is not unconformable for the user. For the second temple 8, the projector 12 is mounted along the temple body 10 adjacent to the temple end 11, which allows the central sight axis of the projector 12 to be oriented normal to the glasses frame 1. Consequently, wherever the user looks with their eyes, is where the projector 12 will display the visual portion of the digital content. The positioning of the wireless module 13 and the projector 12 will also balance the present invention about the bridge 4. In addition, the first portable power source 16 is integrated into the temple tip 9 of the first temple 7, and the second portable power source 17 is integrated into the temple tip 9 of the second temple 8, which allows either the first portable power source 16 or the second portable power source 17 to weigh down the temple tip 9 on the respective user's ear. In the preferred embodiment of the present invention, the first headphone speaker 14 is connected adjacent to the temple tip 9 of the first temple 7, opposite to its temple body 10. Also in the preferred embodiment, the second headphone speaker 15 is connected adjacent to the temple tip 9 of the second temple 8, opposite its temple body 10. These configurations allow their respective headphone speaker to be easily positioned within the appropriate user's ear in order to listen to the audio portion of the digital content. In alternative embodiments of the present invention, the first headphone speaker 14 and the second headphone speaker 15 may feature various other designs. For example, the first headphone speaker 14 and the second headphone speaker 15 may feature an over-the-ear design in lieu of the in-ear design of the preferred embodiment.

In one embodiment of the present invention, the projector is able to the stereoscopic video or images, and thus, a first stereoscopic lens is mounted within the first lens rim, and a second stereoscopic lens is mounted within the second lens rim. The projector, the first stereoscopic lens, and the second stereoscopic lens can be, but is not limited to, a color anaglyph system a polarization system, and an interference filter system.

Although the invention has been explained in relation to its preferred embodiment, it is to be understood that many other possible modifications and variations can be made without departing from the spirit and scope of the invention as hereinafter claimed.

What is claimed is:

1. A pair of projector glasses comprises:
a glasses frame;
a first temple;
a second temple;
a projector;
a wireless module;
a first headphone speaker;
a second headphone speaker;
said first temple and said second temple being positioned opposite to each other along said glasses frame;
said first temple being hingedly connected to said glasses frame;
said second temple being hingedly connected to said glasses frame;
said wireless module laterally mounted onto said first temple;
said projector being laterally mounted onto said second temple;
said first headphone speaker being ergonomically mounted to said first temple;
said second headphone speaker being ergonomically mounted to said second temple; and
said projector, said first headphone speaker, and said second headphone speaker being communicably coupled to said wireless module.

2. The pair of projector glasses as claimed in claim 1 comprises:
a first portable power source;
said first portable power source being integrated into said first temple; and
said first portable power source being electrically connected to said first headphone speaker and said wireless module.

3. The pair of projector glasses as claimed in claim 1 comprises:
a second portable power source;
said second portable power source being integrated into said second temple; and
said second portable power source being electrically connected to said second headphone speaker and said projector.

4. The pair of projector glasses as claimed in claim 1 comprises:
said projector being oriented normal to said glasses frame.

5. The pair of projector glasses as claimed in claim 1 comprises:
said glasses frame comprises a first lens rim, a second lens rim, a bridge, a first end point, and a second end point;
said bridge being ergonomically connected between said first lens rim and said second lens rim;
said first end point being connected adjacent to said first lens rim, opposite to said bridge;
said first end point being hingedly connected to a temple end of said first temple;
said second end point being connected adjacent to said second lens rim, opposite to said bridge; and
said second end point being hingedly connected a temple end of said second temple.

6. The pair of projector glasses as claimed in claim 1 comprises:
said first temple comprises a temple tip, a temple body, and a temple end;
said temple tip and said temple end being positioned opposite of each other along said temple body;
said wireless module being mounted along said temple body adjacent to the temple end;
said first portable power source being integrated into said temple tip; and
said first headphone speaker being connected adjacent to said temple tip, opposite to said temple body.

7. The pair of projector glasses as claimed in claim 1 comprises:
said second temple comprises a temple tip, a temple body, and a temple end;
said temple tip and said temple end being positioned opposite of each other along said temple body;
said projector being mounted along said temple body adjacent to the temple end;
said second portable power source being integrated into said temple tip; and
said second headphone speaker being connected adjacent to said temple tip, opposite to said temple body.

8. A pair of projector glasses comprises:
a glasses frame;
a first temple;
a second temple;
a projector;
a wireless module;
a first headphone speaker;
a second headphone speaker;
a first portable power source;
a second portable power source;
said first temple and said second temple being positioned opposite to each other along said glasses frame;
said first temple being hingedly connected to said glasses frame;
said second temple being hingedly connected to said glasses frame;
said wireless module laterally mounted onto said first temple;
said projector being laterally mounted onto said second temple;
said first headphone speaker being ergonomically mounted to said first temple;
said second headphone speaker being ergonomically mounted to said second temple;
said projector, said first headphone speaker, and said second headphone speaker being communicably coupled to said wireless module;
said first portable power source being integrated into said first temple;
said first portable power source being electrically connected to said first headphone speaker and said wireless module;
said second portable power source being integrated into said second temple; and
said second portable power source being electrically connected to said second headphone speaker and said projector.

9. The pair of projector glasses as claimed in claim 8 comprises:
said projector being oriented normal to said glasses frame.

10. The pair of projector glasses as claimed in claim 8 comprises:
said glasses frame comprises a first lens rim, a second lens rim, a bridge, a first end point, and a second end point;
said bridge being ergonomically connected between said first lens rim and said second lens rim;
said first end point being connected adjacent to said first lens rim, opposite to said bridge;
said first end point being hingedly connected to a temple end of said first temple;
said second end point being connected adjacent to said second lens rim, opposite to said bridge; and
said second end point being hingedly connected a temple end of said second temple.

11. The pair of projector glasses as claimed in claim 8 comprises:
said first temple comprises a temple tip, a temple body, and a temple end;
said temple tip and said temple end being positioned opposite of each other along said temple body;
said wireless module being mounted along said temple body adjacent to the temple end;
said first portable power source being integrated into said temple tip; and
said first headphone speaker being connected adjacent to said temple tip, opposite to said temple body.

12. The pair of projector glasses as claimed in claim 8 comprises:
said second temple comprises a temple tip, a temple body, and a temple end;
said temple tip and said temple end being positioned opposite of each other along said temple body;
said projector being mounted along said temple body adjacent to the temple end;
said second portable power source being integrated into said temple tip; and
said second headphone speaker being connected adjacent to said temple tip, opposite to said temple body.

13. A pair of projector glasses comprises:
a glasses frame;
a first temple;
a second temple;
a projector;
a wireless module;
a first headphone speaker;
a second headphone speaker;
a first portable power source;
a second portable power source;
said first temple and said second temple being positioned opposite to each other along said glasses frame;
said first temple being hingedly connected to said glasses frame;
said second temple being hingedly connected to said glasses frame;
said wireless module laterally mounted onto said first temple;
said projector being laterally mounted onto said second temple;
said first headphone speaker being ergonomically mounted to said first temple;
said second headphone speaker being ergonomically mounted to said second temple;
said projector, said first headphone speaker, and said second headphone speaker being communicably coupled to said wireless module;
said first portable power source being integrated into said first temple;
said first portable power source being electrically connected to said first headphone speaker and said wireless module;
said second portable power source being integrated into said second temple;
said second portable power source being electrically connected to said second headphone speaker and said projector; and
said projector being oriented normal to said glasses frame.

14. The pair of projector glasses as claimed in claim 13 comprises:
said glasses frame comprises a first lens rim, a second lens rim, a bridge, a first end point, and a second end point;
said bridge being ergonomically connected between said first lens rim and said second lens rim;
said first end point being connected adjacent to said first lens rim, opposite to said bridge;
said first end point being hingedly connected to a temple end of said first temple;
said second end point being connected adjacent to said second lens rim, opposite to said bridge; and
said second end point being hingedly connected a temple end of said second temple.

15. The pair of projector glasses as claimed in claim 13 comprises:
said first temple comprises a temple tip, a temple body, and a temple end;
said temple tip and said temple end being positioned opposite of each other along said temple body;
said wireless module being mounted along said temple body adjacent to the temple end;
said first portable power source being integrated into said temple tip; and
said first headphone speaker being connected adjacent to said temple tip, opposite to said temple body.

16. The pair of projector glasses as claimed in claim 13 comprises:
said second temple comprises a temple tip, a temple body, and a temple end;
said temple tip and said temple end being positioned opposite of each other along said temple body;
said projector being mounted along said temple body adjacent to the temple end;
said second portable power source being integrated into said temple tip; and
said second headphone speaker being connected adjacent to said temple tip, opposite to said temple body.
